(19) United States
(12) Patent Application Publication
(10) Pub. No.: US 2016/0015580 A1
(43) Pub. Date: Jan. 21, 2016

(54) LEVER-OPERATED WHEELCHAIR

(71) Applicant: The Regents of the University of California, Oakland, CA (US)

(72) Inventors: Daniel Zondervan, Long Beach, CA (US); David Reinkensmeyer, Irvine, CA (US); Brendan Smith, Long Beach, CA (US)

(21) Appl. No.: 14/745,411

(22) Filed: Jun. 20, 2015

Related U.S. Application Data
(60) Provisional application No. 62/014,963, filed on Jun. 20, 2014.

(51) Int. Cl. A61G 5/02

(52) U.S. Cl. CPC A61G 5/025; A61G 5/022

(57) ABSTRACT

In one embodiment, a wheelchair drive mechanism adapted to mount to a wheelchair includes a drive lever adapted to be rotated forward and rearward by a user of the wheelchair, a clutch mechanism associated with the drive lever, wherein actuation of the clutch mechanism causes the drive lever to be coupled to a wheel of the wheelchair such that they rotate together, and a clutch actuation device provided on the drive lever that is operable by the wheelchair user to actuate the clutch mechanism.

### CROSS-REFERENCE TO RELATED APPLICATION

This application claims priority to co-pending U.S. Provisional Application Ser. No. 62/014,963, filed Jun. 20, 2014, which is hereby incorporated by reference herein in its entirety.

### NOTICE OF GOVERNMENT-SPONSORED RESEARCH

This invention was made with Government support under grant/contract number H133E120010, awarded by the National Institute on Disability and Rehabilitation Research (NIDRR). The Government has certain rights in the invention.

### BACKGROUND

After having a stroke, a patient normally spends time in a hospital where he or she can be observed and provided with care until becoming healthy enough for discharge. During the hospital stay, the patient is typically moved from place-to-place within the hospital or to other health care facilities with a wheelchair that is pushed by hospital staff. While such movement is effective, it does not require any effort on the part of the patient. This is unfortunate as a patient's limbs, including the arms, are often weak after a stroke and requiring the patient to use the arms to propel the wheelchair could help restore the patient's arm strength and function.

Although conventional wheelchairs often have hoops mounted to the wheels that enable healthy individuals to drive the chair, stroke patients often lack the strength and/or range of motion to propel the wheelchair in this manner. While other manual drive mechanisms have been developed beyond wheel hoops, they also normally require strength or a range of motion that recent stroke victims do not possess.

In view of the above discussion, it can be appreciated that it would be desirable to have a wheelchair that can be more easily manually operated by a user sitting in the chair.

### BRIEF DESCRIPTION OF THE DRAWINGS

The present disclosure may be better understood with reference to the following figures. Matching reference numerals designate corresponding parts throughout the figures, which are not necessarily drawn to scale.

FIG. 1 is a side perspective view of a first embodiment of a wheelchair drive mechanism attached to the wheel and frame of a wheelchair.

FIG. 2 is a detail view of a tensioning mechanism of the wheelchair drive mechanism of FIG. 1.

FIG. 3 is a detail view of a clutch mechanism of the wheelchair drive mechanism of FIG. 1.

FIG. 4 is a detail view of the wheelchair drive mechanism of FIG. 1 showing sensors used to automatically control a clutch mechanism of the wheelchair drive mechanism.

FIGS. 5A and 5B are detail views of a transmission of the wheelchair drive mechanism of FIG. 1, illustrating two different configurations of the transmission.

FIG. 6 is a side perspective view of a second embodiment of a wheelchair drive mechanism attached to the wheel and frame of a wheelchair.

FIG. 7 is a partial perspective view of a drive lever of a wheelchair drive mechanism showing a first electrical switch used to actuate a clutch mechanism of the wheelchair drive mechanism.

FIG. 8 is a partial perspective view of a drive lever of a wheelchair drive mechanism showing a second electrical switch used to actuate a clutch mechanism of the wheelchair drive mechanism.

FIG. 9 is a side perspective view of an alternative clutch mechanism that can be used in a wheelchair drive mechanism.

FIG. 10 is an exploded view of the clutch mechanism shown in FIG. 9

### DETAILED DESCRIPTION

As described above, it can be appreciated that it would be desirable to have a wheelchair that can be more easily manually operated by a user sitting in the chair. Disclosed herein are examples of such wheelchairs and their components. The wheelchairs comprise drive levers that can be moved forward and rearward by the user to manually propel the wheelchair. In some embodiments, forearm supports are mounted to the levers that help support the user's arms and therefore facilitate manipulation of the levers. In addition, tensioning mechanisms are associated with the levers that apply tension to the levers that opposes both forward and rearward movement of the levers. As is described below, such tension can assist the user in both driving and stopping the wheelchair.

In the following disclosure, various specific embodiments are described. It is to be understood that those embodiments are example implementations of the disclosed inventions and that alternative embodiments are possible. All such embodiments are intended to fall within the scope of this disclosure.

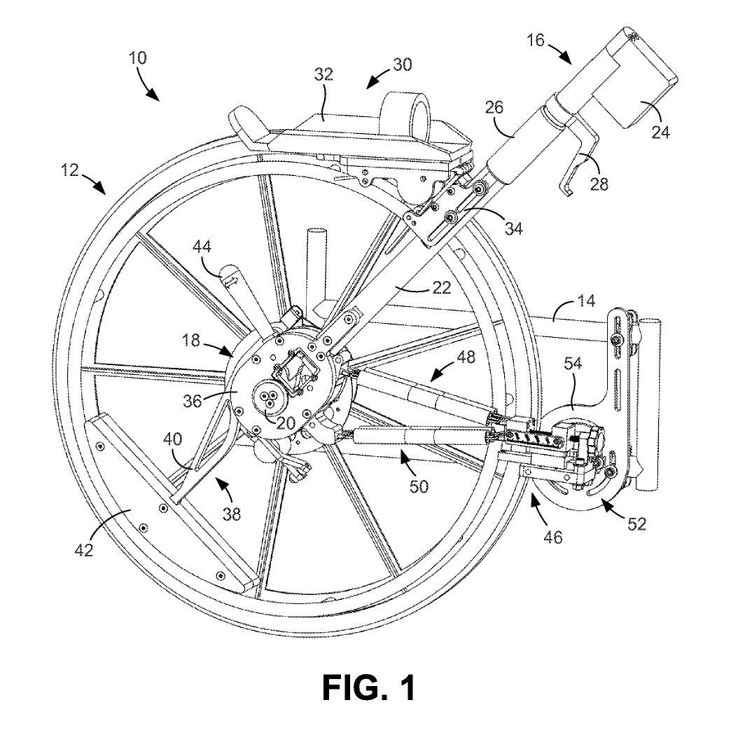

FIG. 1 illustrates a first embodiment of a wheelchair drive mechanism 10. Although only one such mechanism 10 is shown, it is noted that a wheelchair can be provided with two such mechanisms, one for each rear wheel of the chair. The drive mechanism 10 is shown mounted to a rear wheel 12 and a frame 14 of a wheelchair. As indicated in FIG. 1, the drive mechanism 10 includes a drive lever 16 that extends outward from the center (axis) of the wheel 12. In the illustrated embodiment, the lever 16 is securely mounted to an optional transmission 18, which is rotatably mounted to a wheel axle 20 to which the wheel 12 is fixedly attached. As such, the transmission 18 and the lever 16 can rotate relative to both the axle 20 and the wheel 12.

In the illustrated embodiment, the drive lever 16 comprises an elongated shaft 22, such as a hollow tube. The shaft 22 extends radially outward from the wheel 12 and its distal end terminates at a position well beyond the outer periphery of the wheel. Mounted to the distal end of the shaft 20 is a weight 24 that, as is described below, helps to both balance the lever 16 and facilitate harmonic resonance of the lever. Located at a position along the shaft 22 proximal of the weight 24 is a hand grip 26 that is adapted to be gripped by the wheelchair user. By way of example, the hand grip 26 is made of a resilient, non-slip material. Positioned adjacent to the hand grip 26 is a clutch actuation device, in the form of a clutch lever 28, which can be used to operate a clutch mechanism associated the wheel 12. Located at a position proximal of the hand grip 26, but still beyond of the periphery of the wheel 12, is a forearm support 30 that is adapted to support a forearm of the wheelchair user. In the illustrated embodiment, the support 30 includes a forearm trough 32 that is secured to the shaft 22 with a mounting bracket 34.

As indicated above, the drive lever 16 is attached to the transmission 18 so that the lever rotates along with the transmission. More particularly, the lever 16 is attached to a housing 36 of the transmission 18, which acts as a mounting member for the lever. Also attached to the transmission housing 36 is a counterweight armature 38 that extends radially outward from the axis the wheel 12 in a direction opposite to that of the lever 16. The armature 38 includes an elongated arm 40 having a counterweight 42 that is mounted to its distal end at a position near the outer periphery of the wheel 12. Like the weight 24, the counterweight 42 helps to both balance the lever 16 and facilitate harmonic resonance of the lever.

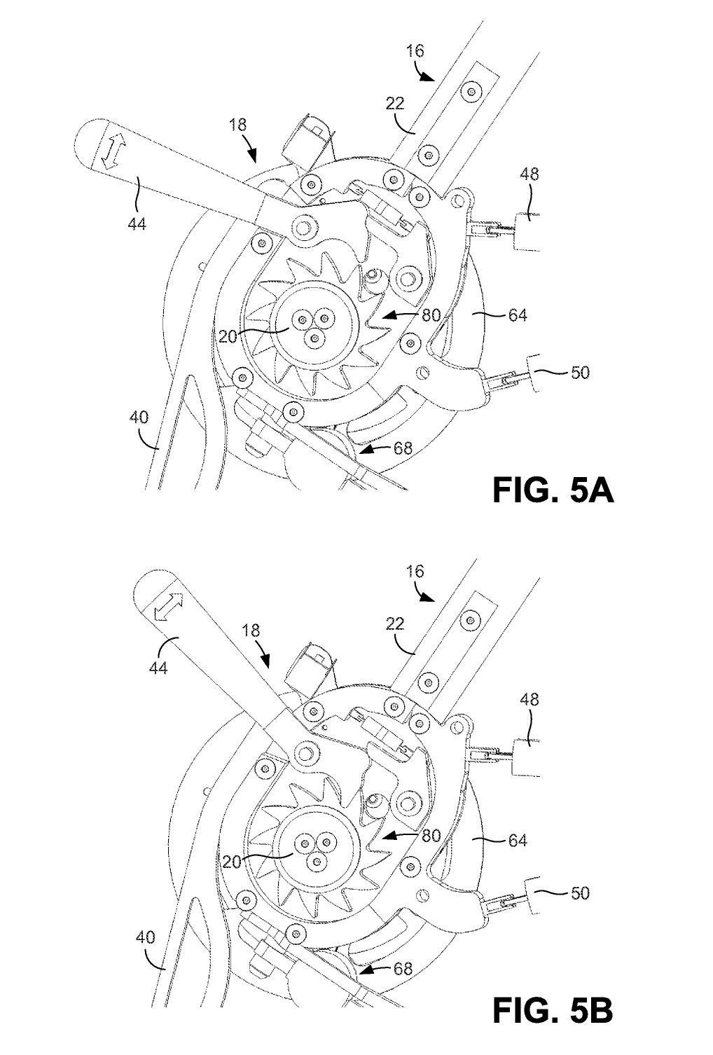

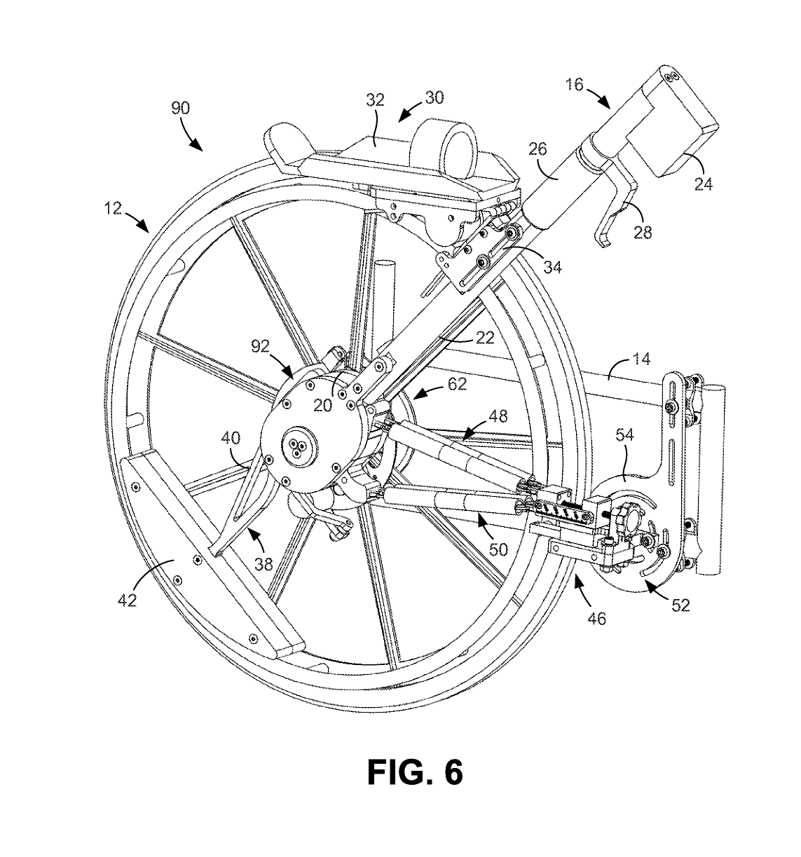

With further reference to FIG. 1, extending outward from the transmission 18 is a selection lever 44 that can be used to place the transmission in one of two different configurations, which are described below in relation to FIGS. 5 and 6.

Further connected to the transmission housing 36 is a tensioning mechanism 46 that applies tension to the transmission housing and, therefore, the drive lever 16. The tensioning mechanism 46 includes a first or upper tensile member 48 and a second or lower tensile member 50. These tensile members 48, 50 are attached at first ends to the transmission housing 36 at positions above and below the axle 20 of the wheel 12, and are attached at second ends to a tension adjustment mechanism 52. As shown in FIG. 1, the first ends of the tensile members 48, 50 are spaced from each other while the second ends of the tensile members are positioned close to each other such that tensile members and the transmission housing 36 together form a triangle. The tension adjustment mechanism 52 is connected to a mounting plate 54, which is mounted to the frame 14 of the wheelchair.

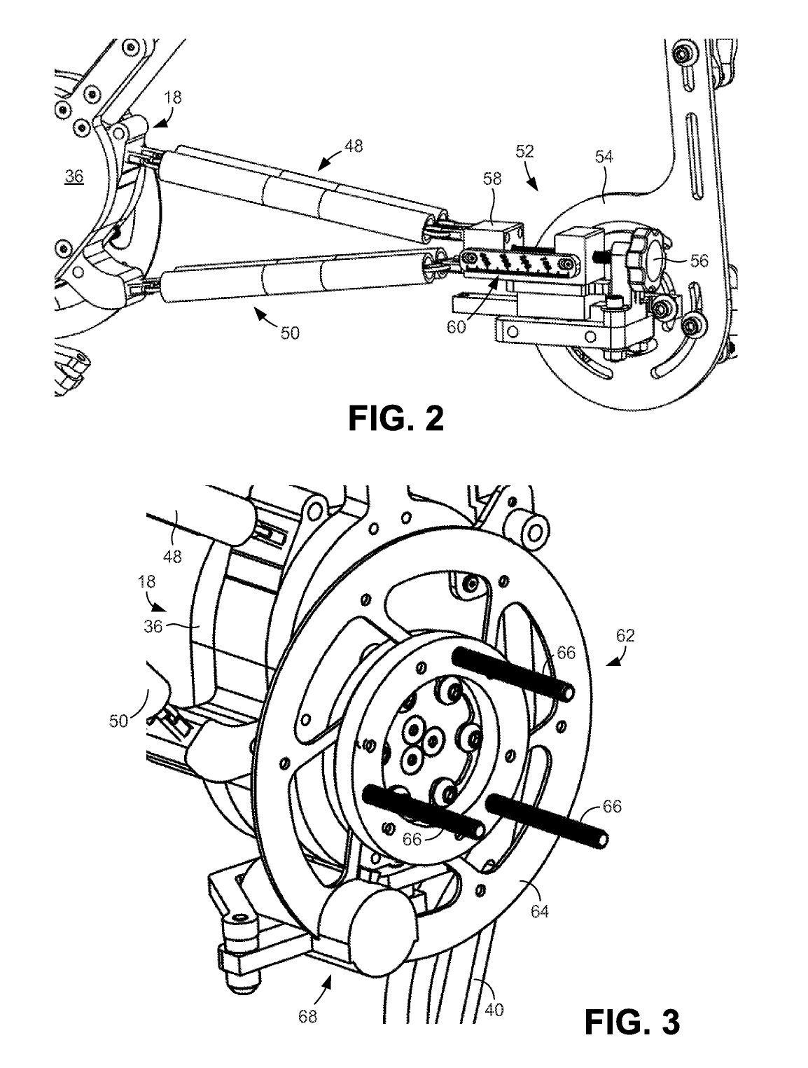

The tensioning mechanism 46 is shown more clearly in the detail view of FIG. 2. The tensile members 48, 50 can comprise any element that can provide tensile resistance to rotation of the transmission housing 36 and, therefore, the drive lever 16. In some embodiments, the tensile members 48, 50 comprise one or more stretched springs or elastic bands. As noted above, the level of tension in the tensile members 48, 50 can be adjusted using the tension adjustment mechanism 52. In particular, an adjustment knob 56 of the mechanism 52 can be rotated to either increase or decrease the tension applied by the tensile members 48, 50. More particularly, rotation of the knob 56 causes linear displacement of a block 58 to which each tensile member 48, 50 is attached. A scale 60 can be provided to give the user an indication of the magnitude of the tension that is applied. Regardless of the level of tension that is applied, the tensile members 48, 50 are held in tension irrespective of the angular position of the transmission housing 36 and lever 16. In such a case, the tensile members 48, 50 continuously pull on the transmission housing 36, which facilitates the harmonic resonance of the lever 16.

In addition to facilitating harmonic resonance of the drive lever 16, the tensioning mechanism 46 serves several other purposes. For example, the tensioning mechanism 46 supports the weight of the lever 16 against gravity. The tensioning mechanism 46 therefore prevents the lever 16 from rotating forward or backward if a user were to release the lever when it is not engaged with the wheel 12. In addition, the tensioning mechanism 46 defines a neutral or resting point for the lever 16 during operation. This ensures that a user manipulates the lever 16 within a consistent range of motion, which improves the ergonomics of the device and can prevent long-term injuries at the shoulder from, for example, over-extension of shoulder and elbow during use. Furthermore, in embodiments in which the wheelchair drive mechanism 10 comprises a clutch mechanism that can be used to drive and stop the wheelchair (described below in relation to FIG. 3), the act of braking the wheelchair by engaging the clutch would transfer the braking force into the levers and, by extension, into a user's arms. This could be uncomfortable and potentially dangerous. However, with the tensioning mechanism 46 integrated into the drive mechanism 10, the braking force is counteracted by the force of the tensile members 48, 50, thus reducing strain on the arm during braking and preventing the lever 16 from being displaced outside of a comfortable range of motion.

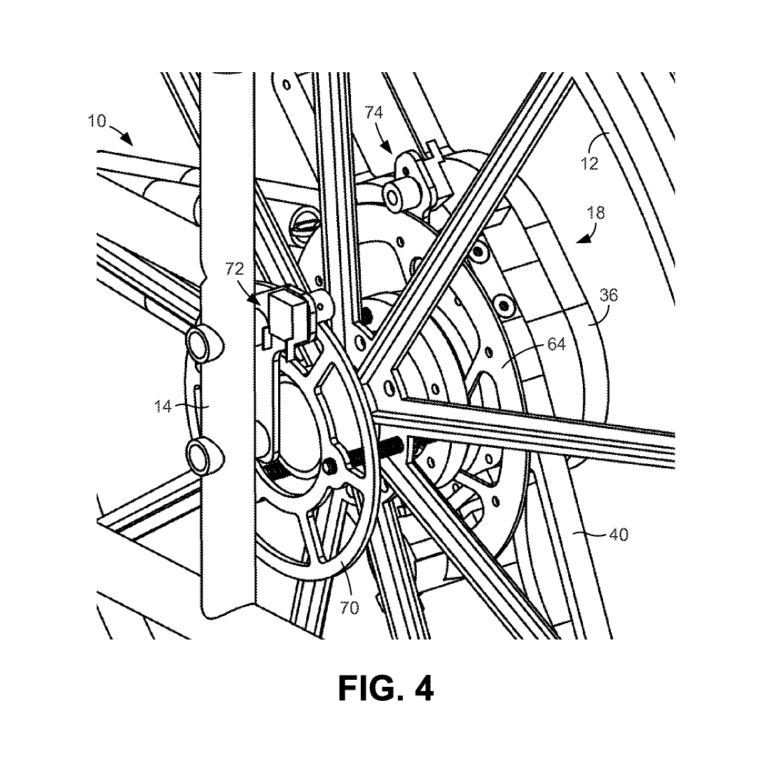

Turning next to FIG. 3, illustrated is a clutch mechanism 62 that can be used to mechanically couple the drive lever 16 to the wheel 12 to enable the user to both propel and stop the wheelchair using the lever. In the example of FIG. 4, the clutch mechanism 62 includes a brake disc 64 that is directly mounted to the wheel 12 with threaded studs 66 and therefore rotates with the wheel. In addition, the clutch mechanism 62 includes brake calipers 68 that are mounted to the transmission housing 36, which are activated when the user squeezes the clutch lever 28 provided near the hand grip 26. When the clutch lever 28 is squeezed, the brake calipers 68 grip the brake disc 64 and place the wheelchair drive mechanism 10 in a “direct-coupling” mode in which the wheel 12 is directly coupled with the drive lever 16 and will rotate with it (and vice versa).

To propel the wheelchair forward, the user can squeeze the clutch lever 28 when the drive lever 16 is in an initial rearward position and, while still squeezing the clutch lever, push the lever forward to cause the wheel 12 to rotate in a forward direction. Once the drive lever 16 has been pushed to a forward position at which the user's arm is extended, the user can then release the clutch lever 28, retract the lever back to the rearward position, and repeat the process to further rotate the wheel 12 in the forward direction. Rotation in the reverse direction can be achieved using an inverse process. Specifically, when the drive lever 16 is in an initial forward position, the user can squeeze the clutch lever 28 and pull the lever rearward to cause the wheel 12 to rotate in a rearward direction. Once the drive lever 16 has been pulled to a rearward position at which the user's arm is bent (e.g., near 90°), the user can then release the clutch lever 28, push the lever back to the forward position, and repeat the process to further rotate the wheel 12 in the rearward direction. Both forward and rearward rotation of the wheel 12 can be halted by opposing such rotation with the lever 16 when the clutch lever 28 is activated.

As can be appreciated from the above description of operation of the clutch mechanism 62, several different types of drive operations can be performed. For example, the user can drive both wheels 12 forward to drive the wheelchair forward, drive both wheels backward to drive the wheelchair backward, or drive one wheel forward while driving another wheel backward to cause the wheelchair to rotate in place.

Irrespective of the drive operation, the user is required to coordinate actuation of the clutch lever 28 with pulling or pushing of the drive lever 16, which may increase the speed of recovery of the user's arm and hand coordination, strength, and range of motion. In some embodiments, a single clutch lever 28 simultaneously operates the clutch mechanisms 62 of each rear wheel 12.

It is further noted that the drive levers 16 can be used even when the clutch mechanism 62 is not engaged. Specifically, when the drive levers 16 are disengaged from the wheels 12, the user can operate the wheelchair drive mechanism 10 in a “freewheeling” mode and simply push and pull the drive levers against the tension provided by the tensioning mechanism 46 to exercise the arms without ambulation. Therefore, the user can exercise his or her arms with relatively little resistance, with harmonic resonance, and without moving the wheelchair from its position. In some embodiments, such exercise can be performed while playing a game, such as an interactive video game in which movement of the lever 16 results in some action occurring within the game.

It is noted that, in some embodiments, the clutch mechanism 62 can be automatically engaged and disengaged by an onboard computer that processes signals from sensors mounted on the wheelchair and manages the timing of switching between freewheeling and direct-coupling modes to achieve different user-specified manners of operation, such as forward movement, backward movement, and direct coupling. FIG. 4 illustrates an example of such an automated embodiment. As shown in this figure, the wheelchair drive mechanism 10 can further include a disc 70 that is securely mounted to the wheel 12. Associated with this disc is a first rotary encoder 72 that is configured to measure the speed with which the disc 70, and therefore the wheel 12, rotates. A second rotary encoder 74 is associated with the brake disc 64 and is configured to measure the speed with which the disc, and therefore the lever 16, rotates. With such apparatus, timing can be optimized such that, when forward driving is desired, the direct-coupling mode is engaged at the precise moment when the forward rotational speed of the drive lever 16 becomes greater than the rotational speed on the wheel 12, and the freewheeling mode is engaged at the precise moment when the forward rotation speed of the lever becomes less than the rotation speed of the wheel. The transition between the freewheeling and direct-coupling modes can be smoothed by controlling the rate at which the clutch mechanism 62 is automatically engaged. This achieves a smoothness not possible through use of a conventional one-way clutch. The desired mode of operation (e.g., forward driving, rearward driving, etc.) can, for example, be controlled using buttons on a control panel positioned adjacent to the handgrip 24 of the drive lever 16.

In addition, certain actions, such as stopping the wheelchair, can be mapped to simple reflexive motions, such as pulling and holding the drive levers in a rearward position (a likely reflex when wanting the chair to stop) or accidentally letting go of a lever such that users with impaired coordination can use the device safely. Such an embodiment emulates all behaviors possible with one-way clutch based devices, but does so with reduced mechanical complexity.

When provided, the transmission 18 enables further types of drive operation. FIGS. 5A and 5B show the internal components of the transmission 18 (part of the transmission housing 36 has been removed) and illustrate the two configurations in which the transmission can be placed. The transmission 18 includes an internal gear 80 that is coupled to the axle 20 of the wheel 12 with a one-way clutch mechanism (not visible) that enables the gear to drive the wheel in the forward direction but idle as the wheel 12 rotates in that direction. FIG. 5A shows a freewheeling configuration of the transmission 18 in which the selection lever 44 is moved to a position in which it does not interface with the teeth of the gear 80. When the selection lever 44 is in this position, the drive lever 16 is decoupled from the wheel 12 and movement of the lever, whether in the forward or rearward direction, has no effect on the wheel, unless the clutch lever 28 is squeezed as described above.

FIG. 5B shows a driving configuration of the transmission 18 in which the selection lever 44 directly interfaces with the teeth of the gear 80. When the selection lever 44 is in this position, forward motion of the drive lever 16 causes the wheel 12 to rotate in the forward direction but rearward motion of the lever does not affect rotation of the wheel. Accordingly, the driving configuration of the transmission 18 can be used to drive the wheelchair forward without requiring the user to operate the clutch mechanism 62. The clutch mechanism 62 could, however, still be used as a brake in that context.

Irrespective of whether the wheelchair is driven forward using the clutch mechanism 62 or the transmission 18 when in its driving configuration, the tensioning mechanism 46, the weight 24, and the counterweight 42 together create a system with a low damping ratio (e.g., approximately 0.01-0.707) that helps the user generate harmonic resonance (e.g., at a frequency of approximately 0.5 to 1.5 Hz) that assists the user in maintaining the back-and-forth motion of the lever 16 and increases the user's range of motion. In addition, the tensioning mechanism 46, and specifically the tensile member 50, assists the user in slowing forward wheel rotation during braking, because the member is stretched as the drive lever 16 is moved forward due to the rotation of the wheel 12.

FIG. 6 illustrates a second embodiment of a wheelchair drive mechanism 90 that is similar in many ways to the mechanism 10 described above. As indicated in FIG. 6, the drive mechanism 90 also includes a drive lever 16 that comprises an elongated shaft 22 to which a weight 24, hand grip 26, and clutch actuation device 28 are mounted. Further mounted to the shaft 22 is a forearm support 30 that includes a forearm trough 32 that is secured to the shaft with a mounting bracket 34.

With further reference to FIG. 6, the drive lever 16 is attached to a mounting member 92 that, like the transmission housing 36 of the first embodiment, is rotatably mounted to an axle 20 to which the wheelchair wheel 12 is fixedly mounted. Also attached to the mounting member 92 is a counterweight armature 38 that includes an elongated arm 40 having a counterweight 42. The wheelchair drive mechanism 90 also comprises a tensioning mechanism 46 that includes a first or upper tensile member 48 and a second or lower tensile member 50 that apply tension to the mounting member 92 and, therefore, the drive lever 16. A tension adjustment mechanism 52 can be used to adjust the tension in the tensile members 48, 50. Furthermore, the drive mechanism 90 includes a clutch mechanism 62.

Unlike the wheelchair drive mechanism 10, however, the wheelchair drive mechanism 90 comprises no transmission and, therefore, no gears that are used to control operation of the wheelchair. Instead, operation of the wheelchair is solely controlled by actuation of the clutch mechanism 62 by the wheelchair user. Such an implementation may be desirable because of its mechanical simplicity and ease of use by the wheelchair user, as well as the therapeutic effects provided by the required coordination between actuating the clutch mechanism 62 and manipulating the drive lever 16.

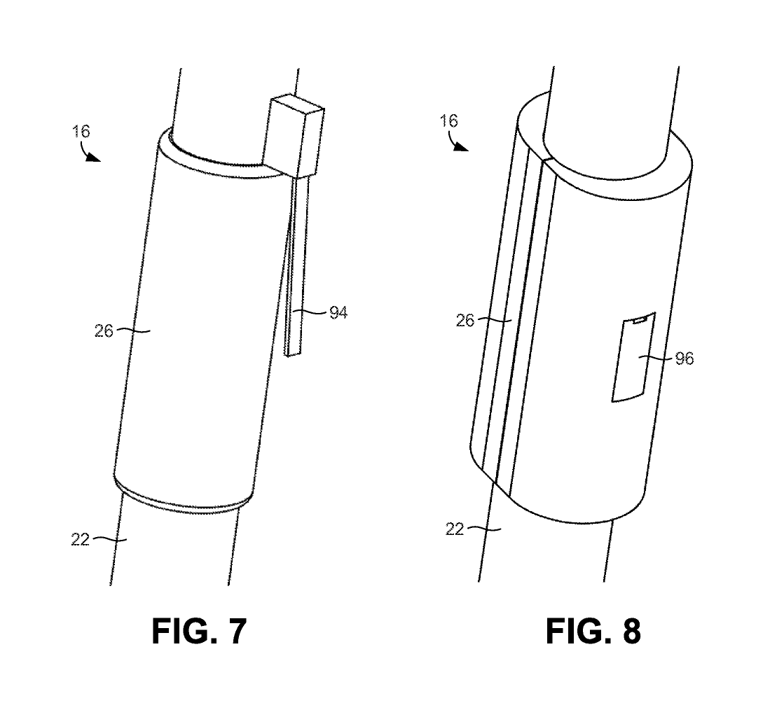

In other embodiments, the actuation of the clutch mechanism can be partially automated. For example, the clutch mechanism can be electromechanically actuated by a solenoid or other electromechanical actuator when the user activates an electrical switch provided on the drive lever. FIGS. 7 and 8 illustrate examples of such switches. With reference first to FIG. 7, the clutch actuation device comprises an electrical clutch lever 94 that is mounted to the shaft 22 of the drive lever 16 adjacent to the hand grip 26 in lieu of a mechanical clutch lever. When the lever 94 is squeezed toward the grip 26, an electrical switch associated with the lever is closed and the electromechanical clutch mechanism is actuated so that the lever 16 is directly coupled to the wheelchair wheel. The clutch mechanism stays activated as long as the electrical switch is held closed but deactivates as soon as the user releases the lever 94 and the switch opens.

Referring next to FIG. 8, the clutch actuation device comprises an electrical button 96 that is integrated into the hand grip 26 so that can be easily pressed by one of the user's fingers. When the button 96 is pressed, an electrical switch associated with the button is closed and the electromechanical clutch mechanism is actuated so that the lever 16 is directly coupled to the wheelchair wheel. In some embodiments, the button 96 is associated with a force sensor, such as a pressure transducer, that measures the force with which the button is pressed and this measurement is used to control the force with which the electromechanical clutch mechanism is actuated. For example, if the button 96 is firmly pressed, the clutch mechanism can be fully engaged so that there is no slippage between the wheel and the drive lever 16. If the sensor 96 is lightly pressed, however, the clutch mechanism can only partially engage such that slippage is permitted. The latter functionality may be desirable in braking situations to enable more gradual braking. It is further noted that, when the wheelchair comprises two drive mechanisms and each has its own clutch actuation device that comprises a button 96 and an associated force sensor, when both buttons are pressed a weighted sum could be taken of the measured forces to determine how much force with which to activate the clutch mechanisms. In such a case, a stronger hand can assist a weaker hand while still requiring the weaker hand to be used.

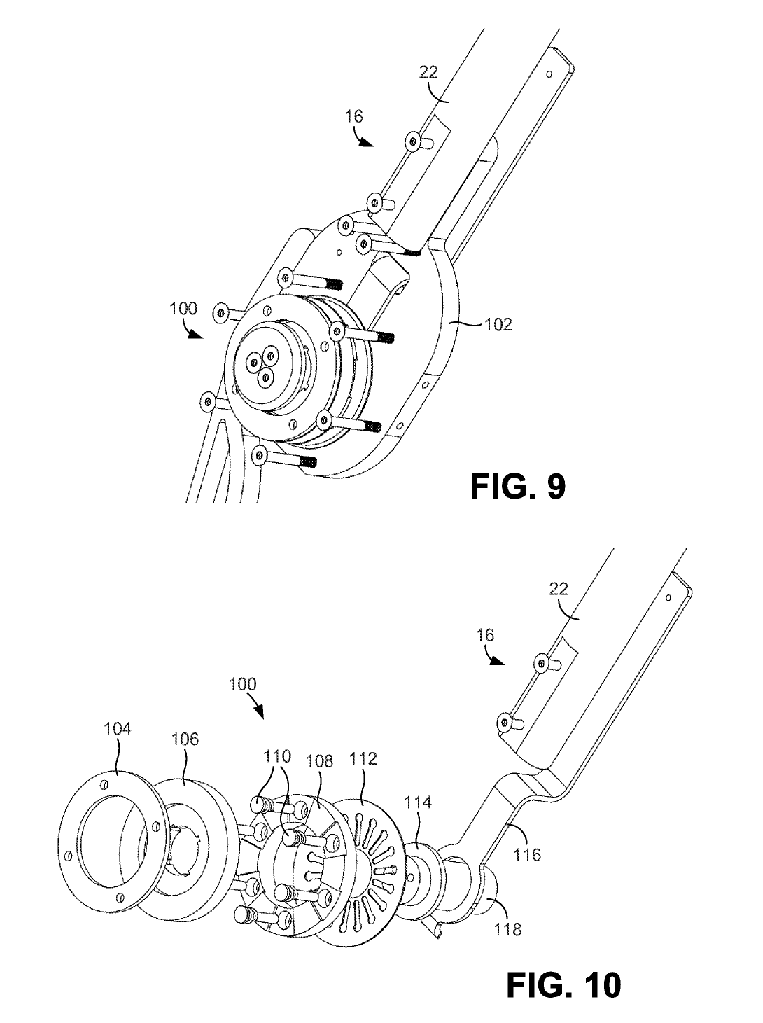

In the above-described embodiments, the clutch mechanism has been shown and described as comprising a brake disc and brake calipers. It is noted that other types of clutch mechanisms can be used. For example, the clutch mechanism can be implemented as a drum brake. Indeed, the clutch mechanism need not comprise a brake at all. In some embodiments, the clutch mechanism can comprise a friction clutch. Such an embodiment is illustrated in FIGS. 9 and 10. Beginning with FIG. 9, illustrated is an assembled friction clutch 100 that is housed within a housing 102 similar to the housing 36 used to contain the transmission 18 described above in relation to the first embodiment.

FIG. 10 shows the friction clutch 100 in an exploded view in which the various components of the clutch can be more easily identified. As indicated in FIG. 10, the friction clutch 100 comprises a backplate 104, a friction disc 106, a pressure plate 108, multiple spring-loaded pins 110 that extend through the pressure plate, a spacer 114, a clutch lever 116 that is attached to the drive lever 16, and a shaft 118. Each of the backplate 104, pressure plate 108, pins 110, and spacer 114 are coupled with the clutch lever 116 and therefore rotate with it, while the friction disc 106 is fixedly mounted to the shaft 118, which is rigidly connected to the wheelchair wheel. The clutch 100 is engaged when the pressure plate 108 is firmly pressed against the friction disc 106, thereby coupling the drive lever 16 and the wheel. During operation, the user can activate the clutch 100 either using a mechanical clutch actuation device or an electrical clutch actuation device. In the former case, the force applied to a clutch lever can be transferred to the pressure plate 108 through a Bowden or hydraulic cable. In the latter case, a solenoid or other electromechanical device can move the pressure plate 108.

Claimed are:

1. A wheelchair drive mechanism adapted to mount to a wheelchair, the drive mechanism comprising:
a drive lever adapted to be rotated forward and rearward by a user of the wheelchair;
a clutch mechanism associated with the drive lever, wherein actuation of the clutch mechanism causes the drive lever to be coupled to a wheel of the wheelchair such that they rotate together; and
a clutch actuation device provided on the drive lever that is operable by the wheelchair user to actuate the clutch mechanism.

2. The drive mechanism of claim 1, wherein the drive lever is adapted to be rotatably mounted to an axle of the wheelchair wheel.

3. The drive mechanism of claim 1, wherein the clutch mechanism comprises a disc brake.

4. The drive mechanism of claim 1, wherein the clutch mechanism comprises a drum brake.

5. The drive mechanism of claim 1, wherein the clutch mechanism comprises a friction clutch.

6. The drive mechanism of claim 1, wherein the clutch actuation device comprises a clutch lever that mechanically actuates the clutch mechanism when the clutch lever is squeezed by the wheelchair user.

7. The drive mechanism of claim 1, wherein the clutch actuation device comprises an electrical switch that electrically actuates the clutch mechanism when the switch is closed by the wheelchair user.

8. The drive mechanism of claim 7, wherein the clutch actuation device further comprises a force sensor that measures a force with which the user activates the clutch actuation device.

9. The drive mechanism of claim 1, wherein the drive lever comprises a forearm support adapted to support a forearm of the wheelchair user.

10. The drive mechanism of claim 1, further comprising a tensioning mechanism that opposes both forward and rearward rotation of the drive lever.

11. The drive mechanism of claim 10, wherein the tensioning mechanism comprises a first tensile member that opposes forward rotation of the drive lever and a second tensile member that opposes rearward rotation of the drive lever.

12. The drive mechanism of claim 11, further comprising a tension adjustment mechanism that is adapted to simultaneously adjust the tension of the first and second tensile members.

13. The drive mechanism of claim 1, further comprising a transmission associated with the wheelchair wheel that is configurable in a freewheeling configuration in which rotation of the drive lever is independent of rotation of the wheelchair wheel and a driving configuration in which forward rotation of the drive lever causes forward rotation of the wheelchair wheel but rearward rotation of the drive lever has no effect on the wheelchair wheel.

14. The drive mechanism of claim 1, further comprising a weight that is associated with the drive lever that facilitates harmonic resonance of the lever.

15. A wheelchair that can be operated by a wheelchair user, the wheelchair comprising:
a wheelchair frame;
a wheel axle supported by the frame;
a rear wheel mounted to the axle; and
a drive mechanism associated with the rear wheel, the drive mechanism including:
a drive lever adapted to be rotated forward and rearward by the wheelchair user,
a clutch mechanism associated with the drive lever, wherein actuation of the clutch mechanism causes the drive lever to be coupled to the rear wheel such that they rotate together, and
a clutch actuation device provided on the drive lever that is operable by the wheelchair user to actuate the clutch mechanism.

16. The wheelchair of claim 15, wherein the drive lever is rotatably mounted to the wheel axle.

17. The wheelchair of claim 15, wherein the clutch actuation device comprises a clutch lever that mechanically actuates the clutch mechanism when the clutch lever is squeezed by the wheelchair user.

18. The wheelchair of claim 15, wherein the clutch actuation device comprises an electrical switch that electrically actuates the clutch mechanism when the switch is closed by the wheelchair user.

19. The wheelchair of claim 18, wherein the clutch actuation device further comprises a force sensor that measures a force with which the user activates the clutch actuation device.

20. The wheelchair of claim 18, wherein the drive lever comprises a forearm support adapted to support a forearm of the wheelchair user.

21. The wheelchair of claim 18, wherein the drive mechanism further comprises a tensioning mechanism that opposes both forward and rearward rotation of the drive lever.

22. The wheelchair of claim 21, wherein the tensioning mechanism comprises a first tensile member that opposes forward rotation of the drive lever and a second tensile member that opposes rearward rotation of the drive lever.

23. The wheelchair of claim 21, wherein the drive mechanism further comprises a tension adjustment mechanism that is adapted to simultaneously adjust the tension of the first and second tensile members.

24. The wheelchair of claim 15, wherein the drive mechanism further comprises a transmission associated with the wheelchair wheel that is configurable in a freewheeling configuration in which rotation of the drive lever is independent of rotation of the wheelchair wheel and a driving configuration in which forward rotation of the drive lever causes forward rotation of the wheelchair wheel but rearward rotation of the drive lever has no effect on the wheelchair wheel.

25. The wheelchair of claim 15, further comprising a second drive mechanism associated with another rear wheel of the wheelchair, the second drive mechanism also comprising a drive lever adapted to be rotated by the wheelchair user and a clutch mechanism associated with the drive lever, wherein the clutch actuation device simultaneously actuates the clutch mechanisms of both drive mechanisms.

26. The wheelchair of claim 15, wherein the drive mechanism further comprises a weight that is associated with the drive lever that facilitates harmonic resonance of the lever.

27. A method for a wheelchair user to operate a wheelchair, the method comprising:
the wheelchair user activating a clutch actuation device to actuate a clutch mechanism that couples a drive lever to a wheel of the wheelchair;
the wheelchair user rotating the drive lever in a first direction from an initial position while still activating the clutch actuation device;
the wheelchair user deactivating the clutch actuation device; and
the wheelchair user rotating the drive lever in a second, opposite direction back toward the initial position.

28. The method of claim 27, wherein activating a clutch actuation device comprises squeezing a lever or pressing a button mounted to the drive lever.

29. The method of claim 27, wherein the lever or button is coupled to an electrical switch that electrically actuates the clutch mechanism.

30. The method of claim 27, wherein rotating the drive lever comprises rotating the drive lever against the force applied by a tensioning mechanism that opposes both forward and rearward rotation of the drive lever.
